(19) United States
(12) Patent Application Publication
(10) Pub. No.: US 2016/0082824 A1
(43) Pub. Date: Mar. 24, 2016

(54) CONTROL DEVICE FOR HYBRID VEHICLES

(71) Applicant: TOYOTA JIDOSHA KABUSHIKI KAISHA, Toyota-shi, Aichi (JP)

(72) Inventor: Toshio INOUE, Gotenba-shi (JP)

(73) Assignee: TOYOTA JIDOSHA KABUSHIKI KAISHA, Toyota-shi, Aichi (JP)

(21) Appl. No.: 14/783,651

(22) PCT Filed: Apr. 15, 2013
(86) PCT No.: PCT/JP2013/061232

§ 371 Date: Oct. 9, 2015

(51) Int. Cl. B60K 6/38

(52) U.S. Cl. CPC B60K 6/38; Y10S 903/946

(57) ABSTRACT

A control device of a hybrid vehicle including an engine, an electric motor coupled to a power transmission path between the engine and drive wheels, and a clutch connecting/disconnecting a power transmission path between the engine and both the electric motor and the drive wheels, the control device detecting engine vibration when an engine water temperature reaches a temperature equal to or less than a predefined low-temperature determination value at which it is predicted that freezing occurs in an intake/exhaust valve of the engine, the control device changing an operation state of the clutch based on a request drive force of the vehicle when the engine vibration is detected, and in which a slip amount of the clutch is made smaller when the request drive force of the vehicle is relatively larger as compared to when the request drive force is relatively smaller.

### TECHNICAL FIELD

The present invention relates to a control device of a hybrid vehicle and particularly relates to improvement in drivability.

### BACKGROUND ART

A technique is proposed for melting freezing when the freezing occurs in a throttle valve of an engine under a low-temperature environment. For example, in a vehicle of Patent Document 1, a motor controlling the opening of the throttle valve via a gear mechanism is used when freezing occurs in a throttle valve, and the motor is accelerated while the motor is rotated by an amount corresponding to a clearance of a gear in the gear mechanism. As a result, a drive force acting on the throttle valve through the gear mechanism from the motor is enhanced so as to escape the throttle valve from a frozen state.

### PRIOR ART DOCUMENT

### Patent Document

Patent Document 1: Japanese Laid-Open. Patent Publication No. 2006-249952

### SUMMARY OF THE INVENTION

### Problem to Be Solved by the Invention

Under a low-temperature environment, it is considered that freezing occurs in not only a throttle value but also an intake/exhaust valve. If the intake/exhaust valve is frozen, the intake/exhaust valve of an engine cannot be successfully closed and compression leakage may occur in a cylinder of the engine. This impedes normal combustion in the cylinder with the frozen valve, which may cause engine vibration leading to deterioration of drivability. In this regard, a conceivable method includes operating the engine to apply vibration, heat, etc. to a frozen portion and melt freezing to eliminate the engine vibration. However, if the engine vibration occurring during engine operation is transmitted to drive wheels, the drivability may deteriorate. Particularly, since a hybrid vehicle stops the engine during running, a frequency of operation of the engine is reduced. Thus, freezing is likely to occur and, therefore, a measure for promptly melting the freezing has been desired.

The present invention was conceived in view of the situations and it is therefore an object of the present invention to provide a control device of a hybrid vehicle, which is capable of eliminating engine vibration without deteriorating drivability when engine vibration is detected, or the occurrence of engine vibration is predicted, during engine operation.

### Means for Solving the Problem

To achieve the object, the principle of the present invention provides a control device of a hybrid vehicle including (a) an engine, an electric motor coupled to a power transmission path between the engine and drive wheels, and a clutch connecting/disconnecting a power transmission path between the engine and both the electric motor and the drive wheels, the control device detecting engine vibration occurring at a temperature equal to or less than a predefined low-temperature determination value at which it is predicted that freezing occurs in an intake/exhaust valve of the engine, the control device (b) changing an operation state of the clutch based on a request drive force of the vehicle when the engine vibration is detected.

### Effects of the Invention

Consequently, when engine vibration is detected during running at the temperature equal to or less than the low-temperature determination value, the operation state of the clutch can be changed depending on the request drive force so as to melt freezing generated in the intake/exhaust valve while suppressing the transmission of the engine vibration generated during engine operation to the drive Wheels and, therefore, the drivability is consequently improved.

In a first preferred form of the invention, when the request drive three of the vehicle is larger, a slip amount of the clutch is made smaller as compared to when the request drive force is smaller. When the request drive force is large, the engine torque and the electric motor torque are used for running of the vehicle. When the request drive three becomes larger, the engine torque also becomes larger and, when the engine torque becomes larger, the engine vibration tends to be smaller because combustion becomes stable. Therefore, even when the slip amount of the clutch is made smaller, the vibration transmitted to the drive wheels is suppressed. If the request drive force is small, the drive force can be covered by the electric motor torque, for example, and therefore, the clutch can be opened or the slip amount can be made larger to suppress the transmission of the engine vibration to the drive wheels.

In a second preferred form of the invention, when the request drive force of the vehicle is covered even by only the electric motor, the clutch is put into an open state. As a result, since the engine vibration is not transmitted to the drive wheels, the drivability can further be improved. The electric motor is used for running and, therefore, the running performance s ensured.

In a third preferred form of the invention, when the request drive force of the vehicle is output by the engine and the electric motor, a slip amount of the clutch is made smaller as a torque of the engine becomes larger. When the engine torque becomes larger, the engine vibration is made smaller because combustion becomes stable. Therefore, even when the slip amount of the clutch is made smaller as the engine torque becomes larger, the engine vibration transmitted to the drive wheels is suppressed because the engine vibration is small, and the vehicle running performance can be ensured.

In a fourth preferred form of the invention, while the engine vibration is detected, the control device changes the operation state of the clutch based on the request drive force of the vehicle and increases an output of the engine. In this way, while the engine vibration is detected, the output of the engine is increased so as to promote an increase in temperature of the intake/exhaust valve and, as a result, melting of freezing in the intake/exhaust valve can be facilitated.

In a fifth preferred form of the invention, the engine vibration is an engine vibration during an irregular explosion cycle.

### BRIEF DESCRIPTION OF THE DRAWINGS

FIG. 1 is a diagram for explaining a general configuration of a power transmission path from an engine and an electric motor to drive wheels making up a hybrid vehicle to which the present invention is preferably applied.

FIG. 2 is a functional block diagram for explaining a main portion of the control function of an electronic control device in FIG. 1.

FIG. 3 is a flowchart for explaining a main portion of the control operation of the electronic control device, i.e., the control operation of eliminating engine vibration without deteriorating drivability when the engine vibration resulting from freezing of an intake/exhaust valve is detected during engine operation.

### MODE FOR CARRYING OUT THE INVENTION

An example of the present invention will now be described in detail with reference to the drawings. In the following example, the figures are simplified or deformed as needed and portions are not necessarily precisely depicted in terms of dimension ratio, shape, etc.

### EXAMPLE

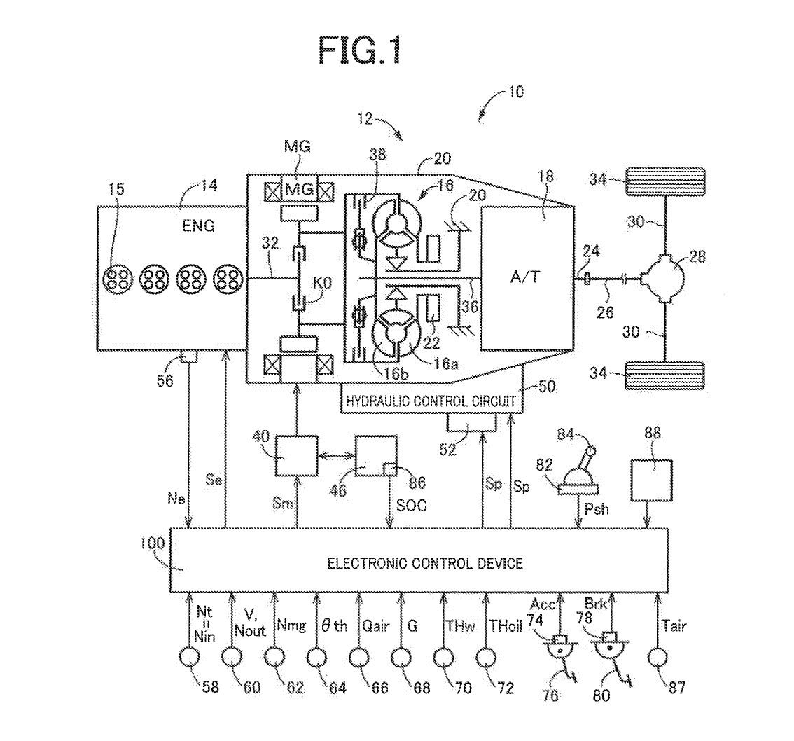

FIG. 1 is a diagram for explaining a general configuration of a power transmission path from an engine 14 and an electric motor MG to drive wheels 34 making up a hybrid vehicle 10 (hereinafter referred to as the vehicle 10) to which the present invention is preferably applied, and is a diagram for explaining a main portion of a control system disposed in the vehicle 10 for output control of the engine 14 acting as a running drive force source, shift control of an automatic transmission 18, drive control of the electric motor MG, etc.

In FIG. 1, a vehicle power transmission device 12 (hereinafter referred to as the power transmission device 12) includes an engine connecting/disconnecting clutch K0, the electric motor MG, a torque converter 16, an oil pump 22, the automatic transmission 18, etc., in order from the engine 14 side in a transmission case 20 (hereinafter referred to as the case 20) acting as a non-rotating member attached to a vehicle body by a bolt etc. The power transmission device 12 also includes a propeller shaft 26 coupled to an output shaft 24 that is an output rotating member of the automatic transmission 18, a differential gear device (differential gear) 28 coupled to the propeller shaft 26, a pair of axles 30 coupled to the differential gear device 28, etc. The power transmission device 12 configured as described above is preferably used in the vehicle 10 of the FR (front-engine rear-drive) type, for example. In the power transmission device 12, if the engine connecting/disconnecting clutch K0 is engaged, the power of the engine 14 is transmitted from an engine coupling shaft 32 coupling the engine 14 and the engine connecting/disconnecting clutch K0, sequentially through the engine connecting/disconnecting clutch K0, the torque converter 16, the automatic transmission 18, the propeller shaft 26, the differential gear device 28, a pair of the axles 30, etc., to a pair of the drive wheels 34. The engine 14 is made up of a four-cylinder four-cycle gasoline engine, for example, and has two intake valves and two exhaust valves disposed for each cylinder. In this example, these two intake valves and two exhaust valves disposed for each cylinder are collectively described as an intake/exhaust valve 15.

The torque converter 16 is a fluid power transmission device transmitting a drive force input to a pump impeller 16a via fluid toward the automatic transmission 18. The pump impeller 16a is coupled sequentially through the engine connecting/disconnecting clutch K0 and the engine coupling shaft 32 to the engine 14 and is an input-side rotating element receiving input of the drive force from the engine 14 and rotatable around an axial center. A turbine impeller 16b of the torque converter 16 is an output-side rotating element of the torque converter 16 and is relatively non-rotatably coupled by spline fitting, etc. to a transmission input shaft 36 that is an input rotating member of the automatic transmission 18. The torque converter 16 includes a lockup clutch 38. The lockup clutch 38 is a direct clutch disposed between the pump impeller 16a and the turbine impeller 16b and is put into an engaged state, a slip state, or an open state by hydraulic control etc.

The electric motor MG is coupled to a power transmission path between the engine 14 and the drive wheels 34 and is a so-called motor generator having a function of a motor generating a mechanical drive force from electric energy and a function of an electric generator generating electric energy from mechanical energy. In other words, the electric motor MG may act as a running drive force source generating a running drive force, instead of the engine 14 that is a power source or along with the engine 14. The electric motor MG also performs operations such as generating electric energy through regeneration from a drive force generated by the engine 14 or a driven force (mechanical energy) input from the drive wheels 34 to accumulate the electric energy via an inverter 40, a boost converter (not depicted), etc. into a battery 46 that is an electric storage device. The electric motor MG is operatively coupled to the pump impeller 16a, and power is mutually transmitted between the electric motor MG and the pump impeller 16a. Therefore, the electric motor MG is coupled to the transmission input shaft 36 in a power transmittable manner as is the case with the engine 14. The electric motor MG is connected to give/receive electric power via the inverter 40, the boost converter (not depicted), etc. to/from the battery 46. In the case of running by using the electric motor MG as the running drive force source, the engine connecting/disconnecting clutch K0 is opened and the power of the electric motor MG is transmitted sequentially through the torque converter 16, the automatic transmission 18, the propeller shaft 26, the differential gear device 28, a pair of the axles 30, etc., to a pair of the drive wheels 34.

The oil pump 22 is a mechanical oil pump coupled to the pump impeller 16a and rotationally driven by the engine 14 (or the electric motor MG) to generate a hydraulic oil pressure for providing the shift control of the automatic transmission 18, controlling a torque capacity of the lockup clutch 38, controlling engagement/open of the engine connecting/disconnecting clutch K0, and supplying lubricant oil to the portions of the power transmission path of the vehicle 10. The power transmission device 12 includes an electric oil pump 52 driven by an electric motor (not depicted) and supplementarily actuates the electric oil pump 52 to generate oil pressure when the oil pump 22 is not driven, for example, during stop of the vehicle.

The engine connecting/disconnecting clutch K0 is a wet multi-plate type hydraulic friction engagement device in which a plurality of friction plates overlapped with each other is pressed by a hydraulic actuator, for example, and is subjected to engagement/open control by a hydraulic control circuit 50 disposed in the power transmission device 12 by using, as an original pressure, an oil pressure generated by the oil pump 22 and the electric oil pump 52. In the engagement/open control, a power-transmittable torque capacity of the engine connecting/disconnecting clutch K0, i.e., an engagement force of the engine connecting/disconnecting clutch K0 is varied, for example, continuously, through pressure adjustment of a linear solenoid valve etc., in the hydraulic control circuit 50. The engine connecting/disconnecting clutch K0 includes a pair of clutch rotating members (a clutch huh and a clutch drum) that are rotatable relative to each other in the open state thereof, and one of the clutch rotating members (the clutch hub) is relatively non-rotatably coupled to the engine coupling shaft 32 while the other clutch rotating member (the clutch drum) is relatively non-rotatably coupled to the pump impeller 16a of the torque converter 16. Because of such a configuration, the engine connecting/disconnecting clutch K0 rotates the pump impeller 16a integrally with the engine 14 via the engine coupling shaft 32 in the engaged state. Therefore, in the engaged state of the engine connecting/disconnecting clutch K0, the drive force from the engine 14 is input to the pump impeller 16a. On the other hand, in the open state of the engine connecting/disconnecting clutch K0, the power transmission between the pump impeller 16a and the engine 14 is interrupted. As described above, since the electric motor MG is operatively coupled to the pump impeller 16a, the engine connecting/disconnecting clutch K0 acts as a clutch connecting/disconnecting the power transmission path between the engine 14 and the electric motor MG. For the engine connecting/disconnecting clutch K0 of this example, a so-called normally open type clutch is used that has a torque capacity (engagement force) increased in proportional to an oil pressure and that is put into an open state while no oil pressure is supplied.

The automatic transmission 18 is coupled to the electric motor MG without via the engine connecting/disconnecting clutch K0 in a power transmittable manner in which the power is transmittable from the motor MG to the transmission 18 without via the clutch K0. The automatic transmission 18 makes up a portion of the power transmission path from the engine 14 and the electric motor MG to the drive wheels 34 to transmit the power from the running drive force source (the engine 14 and the electric motor MG) toward the drive wheels 34. For example, the automatic transmission 18 is a planetary-gear type multistage transmission acting as a stepped automatic transmission in which a shift is made to selectively establish a plurality of shift stages (gear stages) by switching any of a plurality of engagement devices to be gripped, for example, hydraulic friction engagement devices such as a clutch C and a brake B (i.e., by engagement and open of the hydraulic friction engagement devices). Therefore, the automatic transmission 18 is a stepped transmission performing a so-called clutch-to-clutch shift frequently used in known vehicles and changes the speed of the rotation input to the transmission input shaft 36 to output the rotation from the output shaft 24. The transmission input shaft 36 is also a turbine shaft rotationally driven by the turbine impeller 16b of the torque converter 16. The automatic transmission 18 has a predetermined gear stage (shift stage) established depending on an accelerator operation of a driver, a vehicle speed V, etc., through the engagement/open control of each of the clutch C and the brake B. When both the clutch C and the brake B are opened in the automatic transmission 18, a neutral state is achieved and the power transmission path between the drive wheels 34 and both the engine 14 and the electric motor MG is interrupted.

Returning to FIG. 1, the vehicle 10 includes an electronic control device 100 including a control device related to hybrid drive control, for example. The electronic control device 100 includes a so-called microcomputer including a CPU, a RAM, a ROM, and an I/O interface, for example, and the CPU executes signal processes in accordance with a program stored in advance in the ROM, while utilizing a temporary storage function of the RAM, to provide various controls of the vehicle 10. For example, the electronic control device 100 provides the output control of the engine 14, the drive control of the electric motor MG including regenerative control of the electric motor MG, the shift control of the automatic transmission 18, the torque capacity control of the lockup clutch 38, the torque capacity control of the engine connecting/disconnecting clutch K0, etc., and is configured separately for the engine control, the electric motor control, the hydraulic control (shift control), etc., as needed.

The electronic control device 100 is supplied with, for example, a signal indicative of an engine rotation speed Ne that is the rotation speed of the engine 14 detected by an engine rotation speed sensor 56; a signal indicative of a turbine rotation speed Nt of the torque converter 16 as an input rotation speed of the automatic transmission 18 detected by a turbine rotation speed sensor 58, i.e., a transmission input rotation speed Nin that is the rotation speed of the transmission input shaft 36; a signal indicative of a transmission output rotation speed Nout that is the rotation speed of the output shaft 24 corresponding to the vehicle speed V or a rotation speed of the propeller shaft 26 as a vehicle speed related value detected by an output shaft rotation speed sensor 60; a signal indicative of an electric motor rotation speed Nmg that is the rotation speed of the electric motor MG detected by an electric motor rotation speed sensor 62; a signal indicative of a throttle valve opening degree 0th that is an opening degree of an electronic throttle valve (not depicted) detected by a throttle sensor 64; a signal indicative of an intake air amount Qair of the engine 14 detected by an intake air amount sensor 66; a signal indicative of longitudinal acceleration G (or longitudinal deceleration G) of the vehicle 10 detected by an acceleration sensor 68; a signal indicative of an engine water temperature THw of the engine 14 detected by a cooling water temperature sensor 70; a signal indicative of a hydraulic oil temperature THoil of the hydraulic oil in the hydraulic control circuit 50 detected by an oil temperature sensor 72; a signal indicative of an accelerator opening degree Acc which is an operation amount of an accelerator pedal 76 as a drive force request amount (driver request output) for the vehicle 10 from a driver, and which is detected by an accelerator opening degree sensor 74; a signal indicative of a brake operation amount Brk which is an operation amount of a brake pedal 80 as a braking power request amount (driver request deceleration) for the vehicle 10 from a driver, and which is detected by a foot brake sensor 78; a signal indicative of a lever position (a shift operation position, a shift position, an operation position) Psh of a shift lever 84, such as known “P”, “N”, “D”, “R”, and “S” positions, detected by a shift position sensor 82; a signal indicative of a charge amount (charge capacity, charge remaining amount) SOC of the battery portion 46 detected by a battery sensor 86; and a signal indicative of an outside air temperature Tair detected by an outside air temperature sensor 87. The electronic control device 100 is supplied with electric power from an accessory battery 88 charged with electric power stepped down by a DC-DC converter (not depicted).

The electronic control device 100 outputs, for example, an engine output control command signal Se for the output control of the engine 14; an electric motor control command signal Sm for controlling the operation of the electric motor MG; and an oil pressure command signal Sp for actuating electromagnetic valves (solenoid valves) included in the hydraulic control circuit 50, the electric oil pump 52, etc, for controlling hydraulic actuators of the engine connecting/disconnecting clutch K0 and the clutch C and the brake B of the automatic transmission 18.

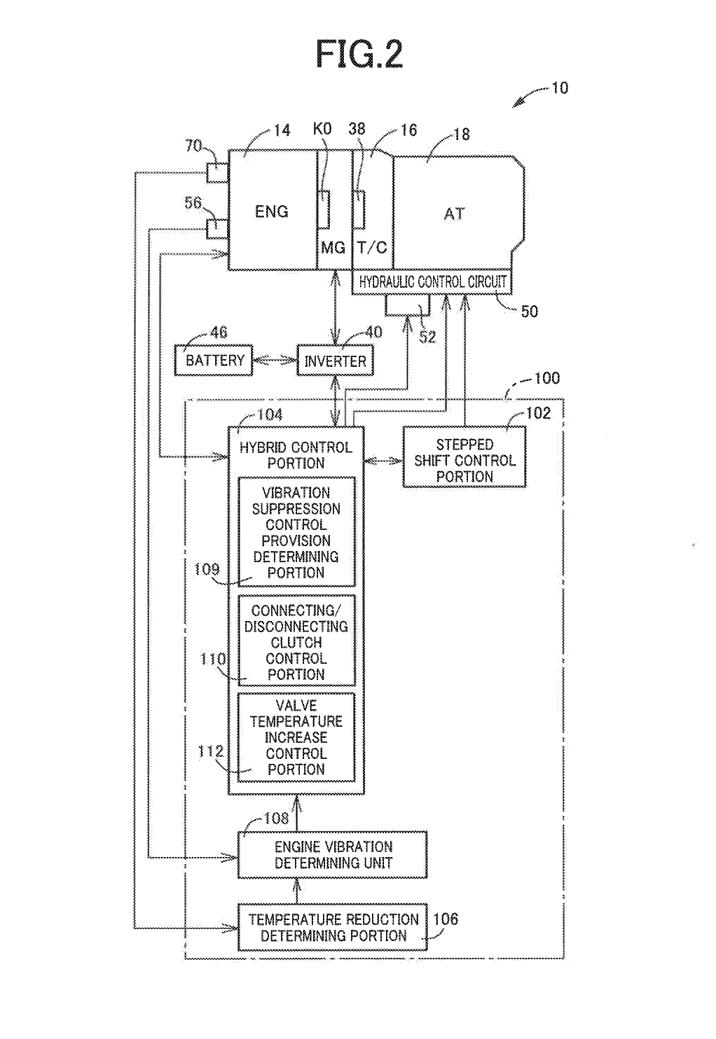

FIG. 2 is a functional block diagram for explaining a main portion of the control function of the electronic control device 100. In FIG. 2, a stepped shift control portion 102 (a stepped shift control means) acts as a shift control portion making a shift of the automatic transmission 18. The stepped shift control portion 102 determines whether a shift of the automatic transmission 18 should be made, for example, based on a vehicle running state indicated by the actual vehicle speed V and accelerator opening degree Acc from a known relationship (shift diagram, shift map) having an upshift line and a downshift line stored in advance by using the vehicle speed V and the accelerator opening degree Ace (or the transmission output torque Tout etc.) as variables, i.e., determines a gear stage to be achieved by the automatic transmission 18 based on the vehicle marling state, and provides the automatic shift control of the automatic transmission 18 such that the determined gear stage is acquired. For example, if the accelerator opening degree Ace (vehicle request torque) exceeds the downshift line to be a higher accelerator opening degree (higher vehicle request torque) in association with an increase in the accelerator opening degree Ace due to an additional depression operation of the accelerator pedal 76, the stepped shift control means 102 determines that a downshift request for the automatic transmission 18 is made, and provides the downshift control of the automatic transmission 18 corresponding to the downshift line. In this case, the stepped shift control means 102 outputs to the hydraulic control circuit 50 a command (shift output command, oil pressure command) Sp engaging and/or opening the engagement devices involved with the shift of the automatic transmission 18 such that the gear stage is achieved in accordance with a predetermined engagement operation table stored in advance, for example. The hydraulic control circuit 50 actuates the linear solenoid valves in the hydraulic control circuit 50 to actuate the hydraulic actuators of the engagement devices involved with the shift such that the shift of the automatic transmission 18 is made by, for example, opening an open-side clutch and engaging an engagement-side clutch in accordance with the command Sp.

A hybrid control portion 104 (a hybrid control means) has a function as an engine drive control portion controlling the drive of the engine 14 and a function as an electric motor actuation control portion controlling the actuation of the electric motor MG as a drive force source or an electric generator through the inverter 40, and provides control of the hybrid drive by the engine 14 and the electric motor MG etc. through these control functions. For example, the hybrid control means 104 calculates a request drive torque Tr of the vehicle from the accelerator opening degree Ace and the vehicle speed V and controls the running drive force source (the engine 14 and the electric motor MG) such that the request drive torque Tr is acquired in consideration of a transmission loss, an accessory load, a gear stage of the automatic transmission 18, the charge amount SOC of the battery 46, etc.

More specifically, for example, if the vehicle request torque Tr is within a range that can be covered solely by the output torque (electric motor torque) Tmg of the electric motor MG, the hybrid control means 104 sets a running mode to a motor running mode (hereinafter, EV running mode) and performs the motor running (EV running) using only the electric motor MG as the running drive force source. On the other hand, for example, if the vehicle request torque Tr is within a range that cannot be covered unless at least the output torque (engine torque) Te of the engine 14 is used, the hybrid control means 104 sets the running mode to an engine running mode (hybrid running mode), and performs the engine running using at least the engine 14 as the running drive force source.

If the EV running is performed, the hybrid control portion 104 opens the engine connecting/disconnecting clutch K0 to interrupt the power transmission path between the engine 14 and the torque converter 16 and causes the electric motor MG to output the electric motor torque Tmg required for the motor running. On the other hand, if the engine running (hybrid running) is performed, the hybrid control means 104 engages the engine connecting/disconnecting clutch K0 to transmit the drive force from the engine 14 to the pump impeller 16a and causes the electric motor MG to output an assist torque as needed. When the oil pump 22 is not driven, for example, during stop of the vehicle, the hybrid control means 104 supplementarily actuates the electric oil pump 52 to prevent a shortage of the hydraulic oil.

If the vehicle request torque Tr (request drive torque) is increased due to, for example, the additional depression operation of the accelerator pedal 76 during the EV running and the electric motor torque Tmg required for the EV running corresponding to the vehicle request drive force Tr exceeds a predetermined EV running torque range in which the EV running can be performed, the hybrid control means 104 switches the running mode from the EV running mode to the engine running mode and starts the engine 14 to perform the engine running. At this start of the engine 14, while engaging the engine connecting/disconnecting clutch K0 toward the complete engagement, the hybrid control means 104 increases the rotation of the engine 14 by transmitting an engine start torque Tugs for engine start from the electric motor MG via the engine connecting/disconnecting clutch K0 and starts the engine 14 by raising the engine rotation speed Ne to a rotation speed enabling self-sustaining operation and by controlling engine ignition, fuel supply, etc. After the engine 14 is started, the hybrid control means 104 promptly achieves the complete engagement of the engine connecting/disconnecting clutch K0.

The hybrid control means 104 has a function as a regenerative control means that allows the electric motor MG to be rotationally driven by kinetic energy of the vehicle 10, i.e., a reverse drive force transmitted from the drive wheels 34 toward the engine 14 and that charges the battery 46 through the inverter 40 with the electric energy so as to improve the fuel consumption during coasting (during inertia running) with acceleration turned off, during braking by depression of the brake pedal 80, etc. This regenerative control is controlled to achieve a regenerative amount determined based on the charge amount SOC of the battery 46, the braking force distribution of a braking force from a hydraulic brake for acquiring a braking force corresponding to a brake pedal operation amount, etc. The hybrid control means 104 engages the lockup clutch 38 during the regenerative control.

Under a low-temperature environment etc., moisture adhering to the intake/exhaust valve 15 of the engine 14 may be frozen, resulting in freezing of the intake/exhaust valve 15. In this case, since the intake/exhaust valve 15 cannot be successfully closed in the cylinder with the intake/exhaust valve 15 frozen, compression leakage may occur and cause engine vibration with an irregular explosion cycle in which a certain cylinder or cylinders do not explode, for example. A method conceivable as a means eliminating this engine variation includes operating the engine to increase a temperature of a frozen portion or apply vibration so as to eliminate the freezing. However, if the engine connecting/disconnecting clutch K0 is in an engaged state during engine operation, the engine vibration occurring during the engine operation is transmitted to the drive wheels 34 and the drivability may deteriorate.

Therefore, when detecting engine vibration resulting from freezing of the intake/exhaust valve 15 in an engine operating state, the electronic control device 100 changes the operation state of the engine connecting/disconnecting clutch K0 depending on the request drive force Tr (request drive torque Tr) of the vehicle. The control of eliminating the engine vibration resulting from freezing of the intake/exhaust valve 15 according to the present invention will hereinafter be described.

Returning to FIG. 2, a temperature reduction determining portion 106 predictively determines the occurrence of freezing of the intake/exhaust valve 15 based on whether the engine water temperature THw is equal to or less than a predefined low-temperature determination value Tlow. The low-temperature determination value Tlow is a value empirically obtained in advance and is set to a temperature at which the freezing of the intake/exhaust valve 15 of the engine 14 occurs (or tends to occur). Therefore, in the state of running at the engine water temperature THw equal to or less than the low-temperature determination value Tlow, it is predictively determined that the freezing has occurred in the intake/exhaust valve 15. Although the engine water temperature THw is applied as a variable (temperature) for determining the occurrence of freezing of the intake/exhaust valve 15 in this example, another variable, for example, the outside air temperature Tair can also be used. Specifically, the variable (temperature) may be any variable enabling estimation of the temperature of the intake/exhaust valve 15.

An engine vibration determining unit 108 is implemented if it is predicted that freezing has occurred in the intake/exhaust valve 15 based on the temperature reduction determining portion 106. The engine vibration determining unit 108 detects engine vibration in a running state in which it is predicted that freezing has occurred in the intake/exhaust valve 15, thereby detecting the engine vibration resulting from the freezing of the valve during engine operation. For example, the engine vibration determining unit 108 sequentially detects the engine rotation speed Ne in every 180-degree rotation of the crank angle of the engine 14 and determines that the engine vibration resulting from the freezing of the intake/exhaust valve 15 has occurred if a difference ΔNe between the detected engine rotation speed Ne and the previously detected engine rotation speed Ne exceeds a preset threshold value α. Alternatively, the engine vibration determining unit 108 sequentially detects an elapse time T in every 30-degree rotation of the crank angle and determines that the engine vibration resulting from the freezing of the intake/exhaust valve 15 has occurred if a change in the elapse time T exceeds a preset threshold value β. The threshold value α and the threshold value β are obtained from an experiment etc. in advance and are set to a value detected when the engine vibration has occurred.

The engine vibration determining unit 108 determines whether the engine vibration is eliminated. The engine vibration determining unit 108 determines that the engine vibration is eliminated if the difference ΔNe of the engine rotation speed Ne becomes less than the threshold value α or if the change in the elapse time T in every 30-degree rotation of the crank angle becomes less than the threshold value β.

If the engine vibration determining unit 108 detects the engine vibration resulting from the freezing of the intake/exhaust valve 15, a vibration suppression control provision determining portion 109 is implemented. The vibration suppression control provision determining portion 109 determines whether the request drive force Tr (or engine request torque Te*) is less than a preset predetermined value Ta. This predetermined value Ta is obtained from a sum (=Tmg+T) which can be output by the electric motor MG and which is determined as a rated value from the charge capacity SOC of the battery 46 etc., and a transmission torque T transmitted from the engine 14 toward the drive wheels 34 when a slip amount S of the engine connecting/disconnecting clutch K0 reaches a preset value Slim. This slip amount Slim is a value obtained empirically in advance and is specifically set to a value at which the engine vibration is reduced in the engine connecting/disconnecting clutch K0 so that almost no vibration is transmitted to the drive wheels 34 (a value at which a driver feels no vibration). When an operation point of the engine 14 (the engine rotation speed Ne, the engine torque Te) changes, the amplitude of the engine vibration also changes. In general, as the engine torque Te becomes larger, the engine vibration tends to be smaller. Considering this fact, the slip amount Slim may be set smaller when the engine torque Te becomes larger.

When the request drive force n is smaller than the predetermined value Ta, a connecting/disconnecting clutch control portion 110 is implemented. The connecting/disconnecting clutch control portion 110 changes the operation state of the engine connecting/disconnecting clutch K0 depending on the request drive force Tr. Specifically, when the request drive force Tr is larger, the connecting/disconnecting clutch control portion 110 makes the slip amount S of the engine connecting/disconnecting clutch K0 smaller as compared to when the request drive force Tr is smaller.

For example, if the request drive force Tr is smaller than the electric motor torque Tmg that can be output by the electric motor MG, the engine torque Te is not required. In such a case, since the engine connecting/disconnecting clutch K0 does not have to be engaged or slipped, the connecting/disconnecting clutch control portion 110 puts the engine connecting/disconnecting clutch K0 into the open state. Therefore, the engine vibration is not transmitted to the drive wheels 34 during engine operation. While the engine connecting/disconnecting clutch K0 is opened, the EV running is performed by the electric motor MG and, therefore, the running performance is ensured.

If the request drive force Tr is larger than the electric motor torque Tmg that can be output, the engine torque Te of the engine 14 and the electric motor torque Tmg of the electric motor MG must be used at the same time for running. In such a case, the engine connecting/disconnecting clutch K0 is slipped to transmit the engine torque Te to the drive wheels 34. In this case, when the slip amount S is smaller, the engine vibration is more easily transmitted to the drive wheels 34 and the connecting/disconnecting clutch control portion 110 provides control such that the slip amount S of the engine connecting/disconnecting clutch K0 becomes at least equal to or greater than the slip amount Slim within a range in which the request drive force Tr can be output. Therefore, since the engine connecting/disconnecting clutch K0 is slipped by the slip amount Slim or more, the engine vibration is reduced when transmitted to the engine connecting/disconnecting clutch K0 and the transmission of the engine vibration to the drive wheels 34 is suppressed. As described above, as the engine torque Te becomes larger, the engine vibration tends to be smaller. Therefore, even when the control is provided such that the slip amount S of the engine connecting/disconnecting clutch K0 becomes smaller as the engine torque Te becomes larger, the running performance can be ensured while suppressing the engine vibration transmitted to the drive wheels 34.

When the request drive force Tr becomes larger than the predetermined value Ta, the connecting/disconnecting clutch control portion 110 is not implemented and, for example, the engine connecting/disconnecting clutch K0 is engaged. In this case, although the engine vibration is almost not reduced by the engine connecting/disconnecting clutch K0, when the request drive force Tr becomes larger, the engine torque Te becomes larger and the engine vibration becomes smaller. Therefore, even when the engine connecting/disconnecting clutch K0 is engaged, since the engine vibration is made smaller due to an increase in the engine torque Te, the vibration transmitted to the drive wheels 34 becomes smaller.

A valve temperature increase control portion 112 is implemented concurrently with the connecting/disconnecting clutch control portion 110 and provides control of promptly increasing the temperature (valve temperature) of the intake/exhaust valve 15 so as to promptly melt freezing of the intake/exhaust valve 15. While the engine vibration is detected, the valve temperature increase control portion 112 increases the output of the engine 14 by increasing the intake air amount Qair of the engine 14 or making the engine rotation speed Ne higher, for example. When these controls are provided, since an increase in engine temperature is promoted during engine operation, an increase in valve temperature is promoted as well and, therefore, the freezing of the intake/exhaust valve 15 is promptly melted. The valve temperature increase control portion 112 promptly increases the valve temperature by advancing or delaying the ignition timing of an ignition device. For example, the valve temperature increase control portion 112 advances the ignition timing into a range in which knocking of the engine 14 does not occur, and thereby improve the combustion efficiency to promptly increases the valve temperature. Alternatively, the valve temperature increase control portion 112 delays the ignition timing and thereby discharge high-temperature exhaust gas from the exhaust valve to promote an increase in valve temperature.

When it is determined that the engine vibration is eliminated based on the engine vibration determining unit 108, the connecting/disconnecting clutch control portion 110 switches to normal operation by causing engagement of the engine connecting/disconnecting clutch K0 etc.

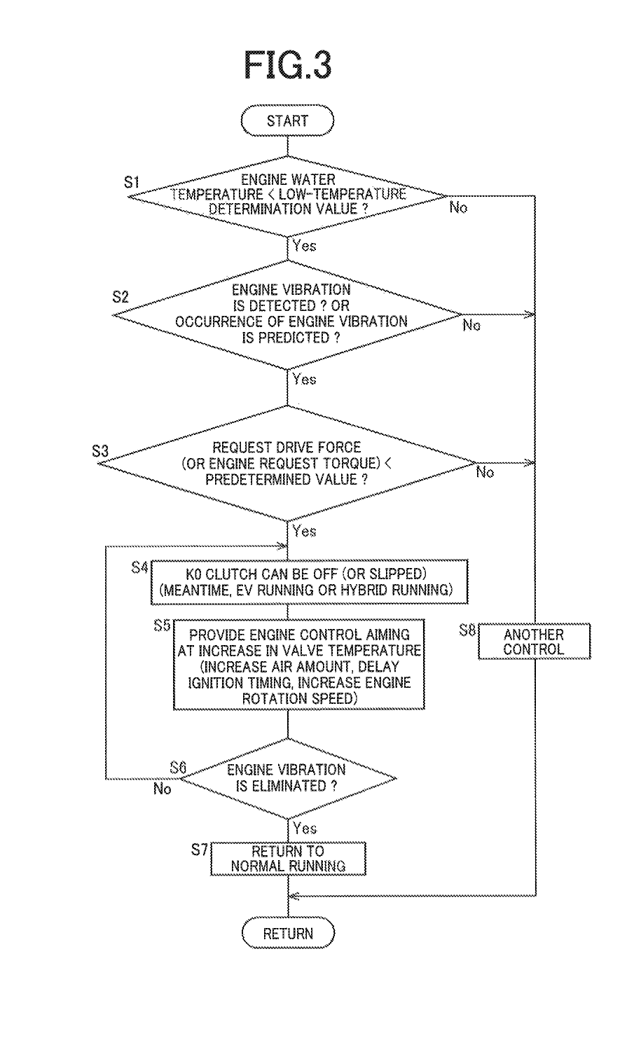

FIG. 3 is a flowchart for explaining a main portion of the control operation of the electronic control device 100, i.e., the control operation of eliminating engine vibration without deteriorating drivability when the engine vibration resulting from freezing of the intake/exhaust valve 15 is detected during engine operation. This flowchart is repeatedly executed with an extremely short cycle time, for example, on the order of few msec to a few tens of msec.

At step S1 (hereinafter, step will be omitted) corresponding to the temperature reduction determining portion 106, the occurrence of freezing of the intake/exhaust valve 15 is predictively determined based on whether the engine water temperature THw is equal to or less than the low-temperature determination value Tlow. If the engine water temperature THw is higher than the low-temperature determination value Tlow, S1 is negative and another control is provided at S8. If the engine water temperature THw is lower than the low-temperature determination value Tlow, S1 is affirmative and, at S2 corresponding to the engine vibration determining unit 108, it is determined whether the engine vibration resulting from the freezing of the valve is detected. If S2 is negative, another control is provided at S8. If S2 is affirmative, it is determined whether the request drive force Tr (or the engine request torque Te*) is less than the preset predetermined value Ta at 53 corresponding to the vibration suppression control provision determining portion 109. If S3 is negative, another control such as engaging the engine connecting/disconnecting clutch K0 is provided at 58. If S3 is affirmative, the engine connecting/disconnecting clutch K0 is controlled between open and slip at 54 corresponding to the connecting/disconnecting clutch control portion 110. The operation state of the engine connecting/disconnecting clutch K0 is controlled within a range in which the engine connecting/disconnecting clutch K0 is opened or slipped (S>Slim) while ensuring the request drive force Tr. S5 corresponding to the valve temperature increase control portion 112 is executed concurrently with S4. At S5, to increase the valve temperature of the engine 14, for example, the intake air amount is increased, the ignition timing of the engine 14 is advanced or delayed, or the engine rotation speed Ne is increased to promptly increase the valve temperature. At S6 corresponding to the engine vibration determining unit 108, it is determined whether the engine vibration is eliminated. If S6 is negative, the operation returns to S4, and S4 and S5 are repeated until the engine vibration is eliminated. If S6 is affirmative, a return to the normal running state is made by providing control such as engagement of the engine connecting/disconnecting clutch K0 etc., at S7 corresponding to the connecting/disconnecting clutch control portion 110.

As described above, according to the example, when engine vibration is detected during running at the engine water temperature THw equal to or less than the low-temperature determination value Tlow, the operation state of the engine connecting/disconnecting clutch K0 can be changed depending on the request drive force Tr so as to melt freezing generated in the intake/exhaust valve 15 while suppressing the transmission of the engine vibration generated during engine operation to the drive wheels 34 and, therefore, the drivability is consequently improved.

According to this example, when the request drive force Tr is larger, the slip amount S of the engine connecting/disconnecting clutch K0 is made smaller as compared to when the request drive force Tr is smaller. When the request drive force Tr is large, the engine torque Te and the electric motor torque Tmg are used for running of the vehicle. When the request drive force Tr becomes larger, the engine torque Te also becomes larger and, when the engine torque Te becomes larger, the engine vibration tends to be smaller because combustion becomes stable. Therefore, even when the slip amount S of the engine connecting/disconnecting clutch K0 is made smaller, the vibration transmitted to the drive wheels 34 is suppressed. If the request drive force Tr is small, the drive force can be covered by the electric motor torque Tmg, for example, and therefore, the engine connecting/disconnecting clutch K0 can be opened or the slip amount can be made larger to suppress the transmission of the engine vibration to the drive wheels 34.

According to this example, if the request drive force Tr is outputtable even by only the electric motor MG, the engine connecting/disconnecting clutch K0 is put into an open state. As a result, since the engine vibration is not transmitted to the drive wheels 34, the drivability can further be improved. The electric motor MG is used for running and, therefore, the running performance is ensured.

According to this example, if the request drive force Tr is output by the engine 34 and the electric motor MG, the slip amount S of the engine connecting/disconnecting clutch K0 is made smaller as the engine torque Te becomes larger. When the engine torque Te becomes larger, the engine vibration is made smaller because combustion becomes stable. Therefore, even when the slip amount S of the engine connecting/disconnecting clutch K0 is made smaller as the engine torque Te becomes larger, the engine vibration transmitted to the drive wheels 34 is suppressed because the engine vibration is small, and the vehicle running performance can be ensured.

According to this example, while the engine vibration is detected, the operation state of the engine connecting/disconnecting clutch K0 is changed based on the request drive force Tr of the vehicle and the output of the engine 14 is increased. In this way, while the engine vibration is detected, the output of the engine 14 is increased so as to promote an increase in temperature of the intake/exhaust valve 15 and, as a result, melting of freezing in the intake/exhaust valve 15 can be facilitated.

Although the example of the present invention has been described in detail with reference to the drawings, the present invention is applied in other forms.

For example, although the connecting/disconnecting clutch control portion 110 opens or slips the engine connecting/disconnecting clutch K0 in this example, the connecting/disconnecting clutch control portion 110 may only open the engine connecting/disconnecting clutch K0.

Although the engine vibration determining unit 108 determines the occurrence of the engine vibration resulting from the freezing of the valve based on the change amount ΔNe of the engine rotation speed Ne in every 180-degree rotation of the crank angle or a change in the elapse time T in every 30-degree rotation of the crank angle, the engine vibration determining unit 108 may determine the engine vibration with another method such as determining the engine vibration from the engine rotation speed Ne of the engine 14 and the electric motor rotation speed Nmg of the electric motor MG, for example.

Although the vehicle power transmission device 12 of the example has the torque converter 16 and the automatic transmission 18 disposed between the electric motor MG and the drive wheels 34, these are not necessarily required. Although the automatic transmission 18 is a planetary-gear type multistage transmission in which a shift is made by switching any of hydraulic friction engagement devices to be gripped, this is an example and a transmission of another form such as a belt type continuously variable transmission may be disposed.

Although the engine 14 is made up of a four-cylinder four-cycle engine in this example, the number of cylinders etc. of the engine is not limited thereto. Although the engine rotation speed Ne in every 180-degree rotation of the crank angle is detected in the engine 14 of this example, the value of crank angle is changed depending on a change in the number of cylinders. Specifically, the value of the crank angle is appropriately changed depending on the explosion cycle of the engine.

Although the occurrence of freezing of the intake/exhaust valve 15 is predictively determined based on the low-temperature determination value Tlow in the example, the determination may be made based on whether the engine 14 is started/stopped during a predetermined period more than the number of times N set in advance, in addition to the low-temperature determination value Tlow.

Although the engine water temperature THw or the outside air temperature Tair is applied as a variable of temperature for determining the occurrence of freezing in this example, the temperature of the intake/exhaust valve 15 can directly be detected by using a sensor to apply this temperature as the variable. Alternatively, for example, the occurrence of freezing can directly be determined through monitoring etc.

The above description is merely an embodiment and the present invention may be implemented in variously modified and improved forms based on the knowledge of those skilled in the art.

### NOMENCLATURE OF ELEMENTS

10: hybrid vehicle
15: intake/exhaust valve
14: engine
100: electronic control device (control device)
MG: electric motor
K0: engine connecting/disconnecting clutch (clutch)

1. A control device of a hybrid vehicle including an engine, an electric motor coupled to a power transmission path between the engine and drive wheels, and a clutch connecting/disconnecting a power transmission path between the engine and both the electric motor and the drive wheels, the control device detecting engine vibration when an engine water temperature reaches a temperature equal to or less than a predefined low-temperature determination value at which it is predicted that freezing occurs in an intake/exhaust valve of the engine,
the control device changing an operation state of the clutch based on a request drive force of the vehicle when the engine vibration is detected, and wherein
a slip amount of the clutch is made smaller when the request drive force of the vehicle is relatively larger as compared to when the request drive force is relatively smaller.

2. (canceled)

3. The control device of claim 1, wherein when the request drive force of the vehicle is covered even by only the electric motor, the clutch is put into an open state.

4. The control device of claim 1, wherein when the request drive force of the vehicle is output by the engine and the electric motor, the slip amount of the clutch is made smaller as a torque of the engine becomes larger.

5. The control device of claim 1, wherein while the engine vibration is detected, the control device changes the operation state of the clutch based on the request drive force of the vehicle and increases an output of the engine.
